(19) United States
(12) Patent Application Publication
(10) Pub. No.: US 2006/0015888 A1
(43) Pub. Date: Jan. 19, 2006

(54) Method of searching for clip differences in recorded video data of a surveillance system

(75) Inventor: Chi-Hsien Shih, Chung Ho City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AverMedia Technologies, Inc

(21) Appl. No.: 11/175,453

(22) Filed: Jul. 6, 2005

(30) Foreign Application Priority Data
Jul. 13, 2004 (TW) 93120873

(51) Int. Cl. H04N 7/16

(52) U.S. Cl. 725/1

(57) ABSTRACT

A method of searching for clip differences in recorded video data of a surveillance system. The method includes the following steps. First, a plurality of first clips are displayed simultaneously on a display. Each first clip displays the same scene but a different time period of the recorded video data. Next, a first clip having the maximum difference compared with adjacent first clips is selected. Next, the time period represented by the selected first clip is further divided into a plurality of time periods and a plurality of second clips are displayed on the display. Each second clip displays the same scene but a different time period of the selected first clip. Subsequent layers of clips are repeatedly divided until the exact time point having the maximum difference is found.

### RELATED APPLICATIONS

The present application is based on, and claims priority from, Taiwan Application Serial Number 93120873, filed Jul. 13, 2004, the disclosure of which is hereby incorporated by reference herein in its entirety.

### FIELD OF THE INVENTION

The present invention relates to a method of searching for clip differences in recorded video data of a surveillance system, and more particularly, to a method of searching for clip differences in recorded video data of a surveillance system by dividing the clip.

### BACKGROUND OF THE INVENTION

With people becoming increasingly more socially active, home and office security is becoming increasingly more important to people. Especially for people living in cities, surveillance systems are commonplace for deterring and helping to solve crimes and for preventing accidents. A surveillance system can automatically record environmental states and can be a tool for collecting evidence when crimes are committed.

When a user of a home surveillance system is out of his house for a long period of time, the surveillance system may need to record the monitored scenes for many days, many months, or even a whole year. If some unusual events occur in the monitored scenes during this period of time, such as a car disappearing or a door and window breaking, the user has to find the point when the incident happened from the recorded surveillance.

However, because the surveillance time is so long, there is a massive amount of recorded data for the user to examine. Intermittent recording does not work effectively since it might miss recording important scene changes.

Therefore, there is a pressing need for a method to search for scenes in a surveillance system. Such a method can search for scenes systematically and promptly to find the point when an incident happens.

### SUMMARY OF THE INVENTION

Therefore, one objective of the present invention is to provide a method of searching for clip differences in the recorded video data of a surveillance system to search for the exact time point having the maximum difference in the recorded video data.

Another objective of the present invention is to provide a method of searching for clip differences in the recorded video data of a surveillance system, which can provide a plurality of clips displaying a plurality of time periods of the recorded video data for selection.

Still another objective of the present invention is to provide a method of searching for clip differences in the recorded video data of a surveillance system, which can promptly classify clips for selection.

According to the aforementioned objectives, the present invention provides a method of searching for clip differences in the recorded video data of a surveillance system. According to a preferred embodiment of the present invention, the method includes the following steps. Firstly, recorded video data of a surveillance system is divided into a plurality of time periods. Next, a plurality of first clips are displayed simultaneously on a display, in which each first clip presents the same scene but a different time period of the recorded video data. Then, the first clip differing the most from the adjacent first clips is selected.

Next, the time period represented by the selected first clip is further divided into a plurality of time periods and a plurality of second clips are displayed simultaneously on the display, in which each second clip presents the same scene but a different time period of the selected first clip. Then, the second clip differing the most from the adjacent second clips is selected.

When the time period represented by the selected second clip is shorter than a predetermined time period, the selected second clip is displayed for searching out the exact time point having the maximum difference in the selected second clip. When the time period represented by the selected second clip is longer than a predetermined time period, the time period represented by the selected second clip is divided into a plurality of time periods to repeatedly use the next layer of clips to search for the exact time point having the maximum difference between the clips.

The present invention comprises the following advantages. It can promptly classify clips for selection and promptly search out the exact time point having the maximum difference between the clips by using the divided clips of different time periods. Furthermore, the method can simultaneously display the clips of different time periods of the recorded video data for selection.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIGS. 1 through 6 illustrate sequential steps of the preferred embodiment of the present invention.

### DETAILED DESCRIPTION OF THE PREFERRED EMBODIMENT

A long-term recording is often proceeded by a surveillance system, and the recorded video data is stored in a storage medium, such as a hard disc. When the user of the surveillance system finds that an unusual incident occurred in the monitored environment, the user has to find the point when the incident happened from the recorded video data.

For example, a surveillance system records the user's car over the span of a year while the user is out of his home, after which time the user returns to discover his car is missing. He then has to examine the recorded data to identify the exact time when the incident happened. The amount of recorded data is huge, though, and sifting through the data is very time-consuming. Therefore, the present invention provides a fine solution to the problem.

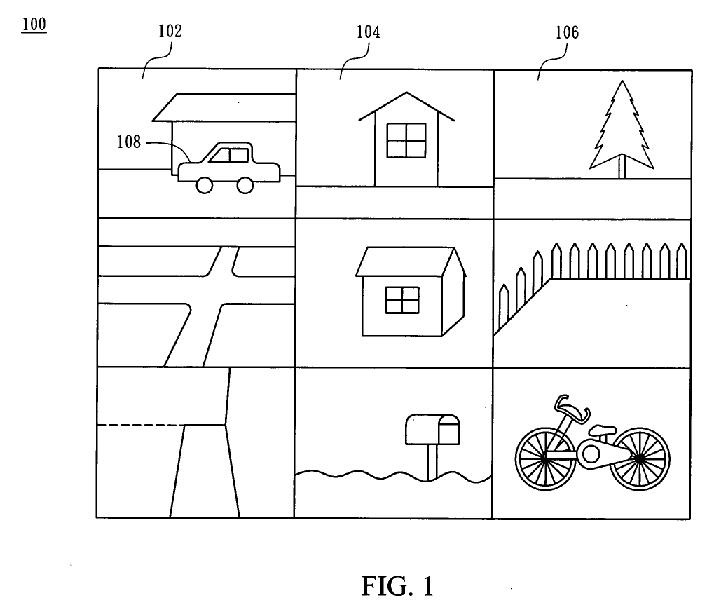

FIG. 1 illustrates a preferred embodiment of the present invention, in which a surveillance system has recorded video data for a long time. The video data are displayed in clips with different scenes on the display of the surveillance system. For example, a clip 102 shows the recorded scene of a car 108, a clip 104 shows the recorded scene of sides of the house, and a clip 106 shows the recorded scene of the surroundings. Before the user of the surveillance system leaves his house, the car 108 in the clip 102 is still there, but the user finds it missing when he returns home.

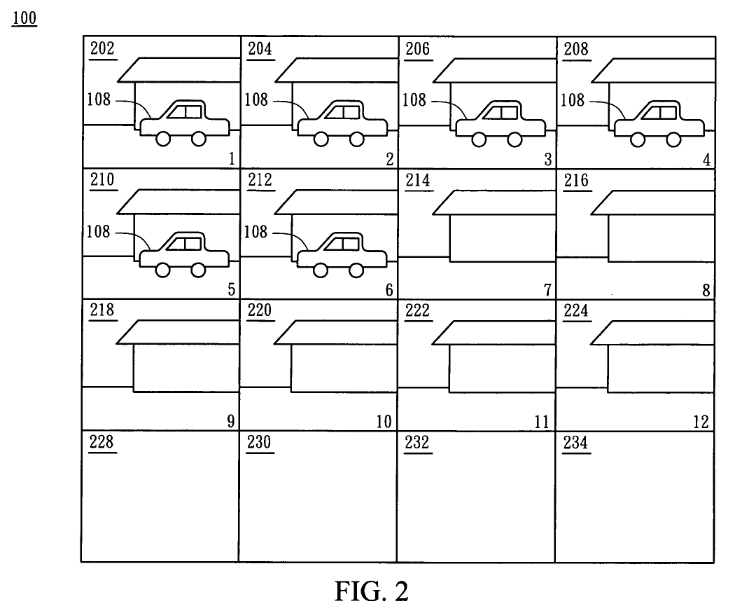

To investigate the incident, the user first selects the clip 102, and the surveillance system automatically divides the clip 102 into a plurality of time periods, as illustrated in FIG. 2. When the user selects the clip 102, the screen 100 displays a plurality of first clips (202˜224) simultaneously, wherein each first clip displays the same scene (i.e., the clip 102 of FIG. 1) but different time periods of the recorded video data.

Supposing that the surveillance system has recorded for one year from January to December (in FIG. 2, the number at the lower-right of each clip represents the month), the following describes how the user can determine the time when the car 108 disappeared. There are sixteen first clips on the screen 100, wherein twelve first clips have recorded data, and each clip shows the recorded data of a one-month time period. For example, the first clip 202 displays the recorded data of January, the first clip 204 displays the recorded data of February, and so on. Each first clip contains the recorded data from the first day to the last day of the month.

The user selects the first clip whose scene is most different from that of the adjacent clip. The user selects a first clip 212 because its scene is most different from that of the first clip 214, which represents the recorded data of July. That is to say, the car 108 is in the first clip 212 (June) but is not in the first clip 214 (July). The user has to determine from the first clip 212 (June) the time when the car 108 disappeared, so the user selects the first clip 212.

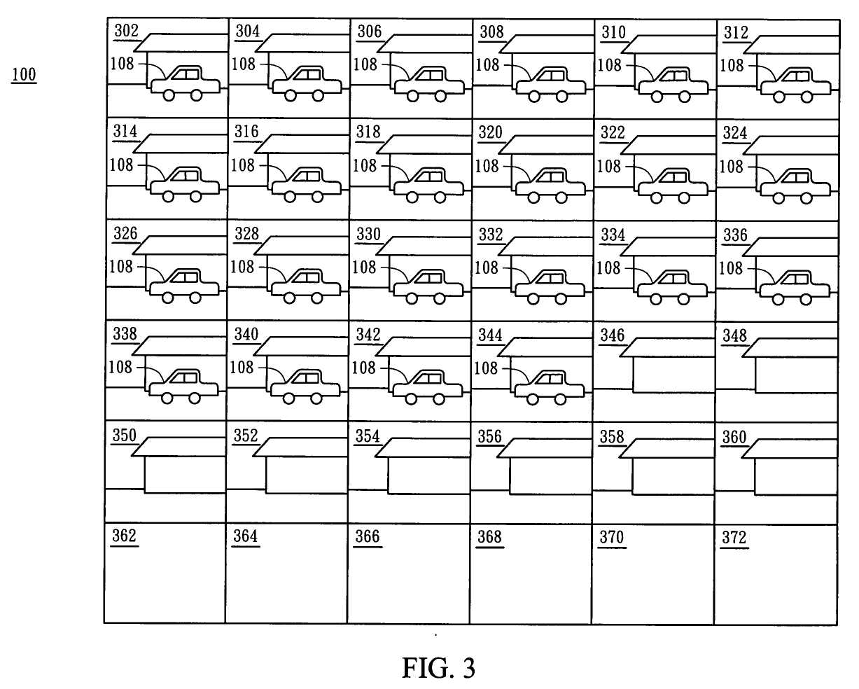

FIG. 3 illustrates the preferred embodiment of the present invention, in which the surveillance system divides the first clip 212 into a plurality of second clips (302˜372) and displays them simultaneously on the screen, wherein each second clip shows the recorded data of a different time period of the first clip 212. As exemplified by FIG. 3, thirty of the total thirty-six second clips (302˜372) represent the days of a thirty-day month, each of which contains the recorded data of a day from midnight to midnight. Thus, the second clip 302 represents the recorded data of June 1 st, the second clip 304 represents the recorded data of June 2nd, and so on.

The user selects the second clip whose scene is most different from that of the adjacent clip. The user selects the second clip 344 because its scene is most different from that of a second clip 346. That is, the car 108 is in the second clip 344 (June 22nd) but is not in the second clip 346 (June 23rd).

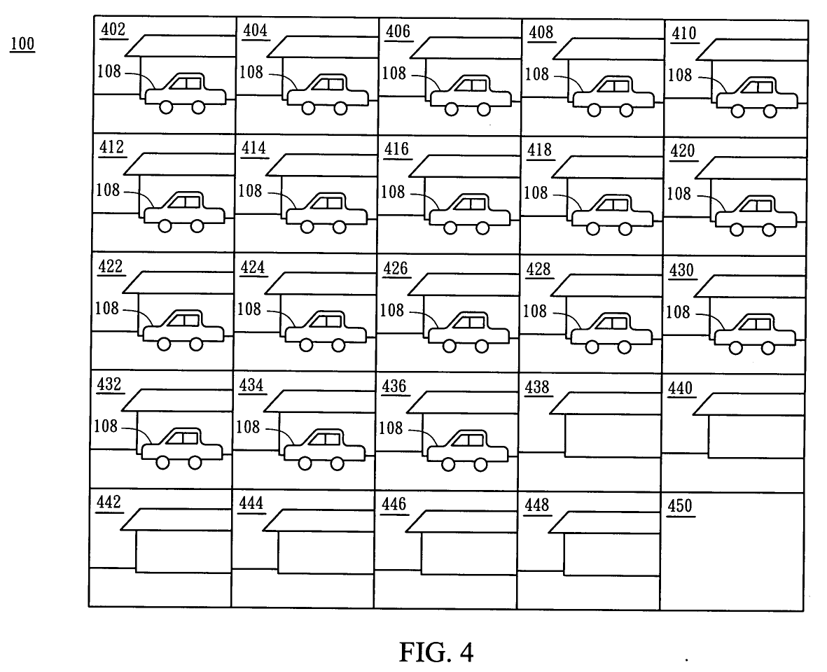

FIG. 4 illustrates the preferred embodiment of the present invention, in which the surveillance system divides the second clip 344 into a plurality of third clips (402˜450) and displays them simultaneously on the screen, wherein each third clip shows the recorded data of a different time period of the second clip 344. As exemplified by FIG. 4, twenty-four of the total twenty-five (5*5) third clips (402˜450) represent the hours of a day, each of which contains the recorded data from the first through the last minute of the hour. Thus, the third clip 402 represents the recorded data of the first hour of a day, the third clip 404 represents the recorded data of the second hour of a day, and so on.

The user selects the third clip whose scene is most different from that of the adjacent clip. The user selects the third clip 436 because its scene is most different from that of the third clip 438. That is, the car 108 is in the third clip 436 (the eighteenth hour) but is not in the third clip 438 (the nineteenth hour).

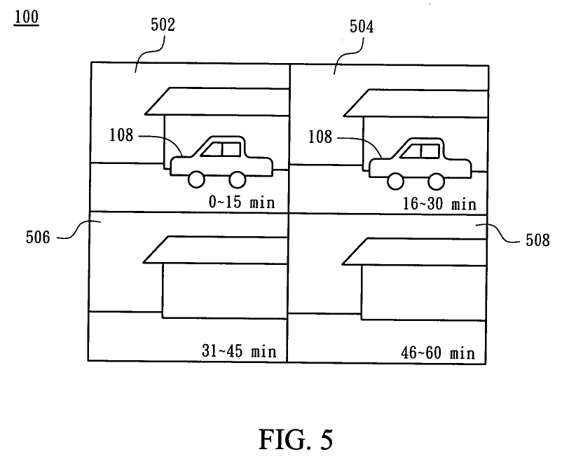

FIG. 5 illustrates the preferred embodiment of the present invention, in which the surveillance system divides the third clip 436 into a plurality of fourth clips (502˜508) and displays them simultaneously on the screen, wherein each fourth clip shows the recorded data of a different time period of the third clip 436. As in FIG. 5, for convenience, an hour is divided into four 15-minute time periods. Thus, the fourth clip 502 represents the recorded data of the first quarter of an hour, the fourth clip 504 represents the recorded data of the second quarter of an hour, and so on. Since the car 108 is in the fourth clip 504 (the second quarter of the hour) but is not in the fourth clip 506 (the third quarter of the hour), the user selects the fourth clip 504.

Supposing that the user has set the minimum time period of the clip as fifteen minutes, when the user selects the fourth clip 504, the screen 100 displays the recorded data for the fifteen minutes comprising the fourth clip 504. Then, the user can determine the exact time when the car 108 disappeared within the fifteen minutes.

The designer can designate the time length of each first clip; the length does not need to be a month. The designer can also designate the time length of each second clip; the length is not limited to a day. And, the designer can designate the time length of each third clip; the length does not need to be an hour.

In another embodiment, the user sets one minute as the minimal time period of the clip. The user further divides the fourth clip 504 into minute-long time periods and clips and subsequently determines the time when the car disappeared within that minute. The designer can freely designate the minimum time period of the clip.

In still another embodiment, the surveillance system does not limit the minimum time period of the clip. The user can repeatedly divide the clips until single frames are displayed. The frame is the smallest unit of a complete clip. In yet another embodiment, for convenience of the user, time information can optionally be displayed on every clip. In a further embodiment, each clip provides the functions to play or stop. All of the aforementioned embodiments can be realized with software added to a surveillance system.

In the examples of FIG. 2 through FIG. 5, the user can discern the clip that is most different from that of the next time period, such as the first clip 212 in FIG. 2, the second clip 344 in FIG. 3, the third clip 436 in FIG. 4, and the fourth clip 504 in FIG. 5.

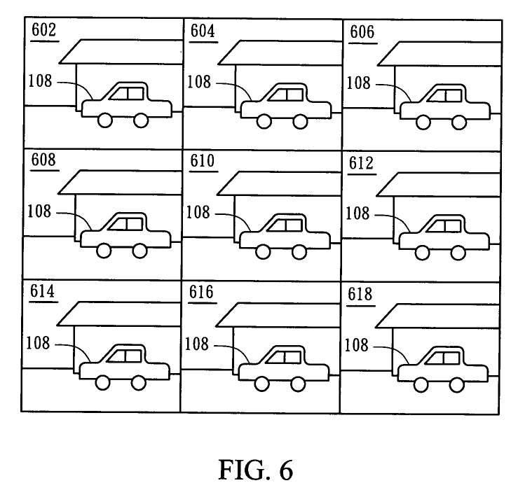

However, a situation may arise, such as illustrated in FIG. 6, wherein the car 108 is not missing until the time period of the last clip 618 and there is no practical clip difference between all the clips. Thus, the user has to further play the clip 618 or divide the clip 618 into shorter time periods to discern a practical clip difference. The so-called “practical clip difference” refers to the monitored object moving or disappearing from one clip to the next. Because there is no practical clip difference between any of the clips (i.e., the car 108 does not move or disappear), the user selects the last clip 618 and further plays it or divides it into shorter time periods.

The situation illustrated in FIG. 6 can happen on the screen of any of FIGS. 2 through 6. When it does happen, the user directly selects the last clip and proceeds to the next step of the method.

The present invention possesses the following advantages. It can promptly classify clips for selection and promptly search out the exact time point having the maximum difference between the clips by using the divided clips of different time periods. Furthermore, the method can simultaneously display the clips of different time periods of the recorded video data for selection. Therefore, the user can save time by not having to examine a vast quantity of recorded data to find the exact time point when an incident happened.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A method of searching for clip differences in recorded video data of a surveillance system, comprising:
dividing recorded video data of a surveillance system into a plurality of time periods;
displaying a plurality of first clips simultaneously on a display, wherein each first clip displays a same scene but a different time period of the recorded video data;
selecting the first clip having the maximum difference compared with an adjacent first clip;
dividing the time period represented by the selected first clip into a plurality of time periods;
displaying a plurality of second clips simultaneously on the display, wherein each second clip displays a same scene but a different time period of the selected first clip;
selecting the second clip having the maximum difference compared with an adjacent second clip;
displaying the selected second clip for determining the exact time point having the maximum difference in the selected second clip when the time period represented by the selected second clip is shorter than a predetermined time period; and
dividing the time period represented by the selected second clip into a plurality of time periods to repeatedly use the next layer of clips to determine the exact time point having the maximum difference between the next layer of clips when the time period represented by the selected second clip is not shorter than the predetermined time period.

2. The method of searching for clip differences in recorded video data of a surveillance system according to claim 1, further including:
displaying a plurality of third clips simultaneously on the display, wherein each third clip displays a same scene but a different time period of the selected second clip; and
selecting the third clip having the maximum difference compared with the adjacent second clip.

3. The method of searching for clip differences in recorded video data of a surveillance system according to claim 1, further including:
displaying N*N clips on the display when dividing the selected clip, wherein N represents a positive integer.

4. The method of searching for clip differences in recorded video data of a surveillance system according to claim 1, further including:
dividing the time period represented by the selected clip into a plurality of time periods; and
displaying the divided clips and selecting the divided clip having the maximum difference compared with the adjacent divided clip repeatedly until the exact time point having the maximum difference in the recorded video data is found.

5. The method of searching for clip differences in recorded video data of a surveillance system according to claim 1, further including:
displaying time information on every clip.

6. The method of searching for clip differences in recorded video data of a surveillance system according to claim 1, wherein the method is implemented with software in the surveillance system.

7. The method of searching for clip differences in recorded video data of a surveillance system according to claim 1, wherein each divided clip provides the function to play or stop.

8. A method of searching for clip differences in recorded video data of a surveillance system, comprising:
dividing the recorded video data of a surveillance system into a plurality of time periods;
displaying a plurality of first clips simultaneously on a display, wherein each first clip displays a same scene but a different time period of the recorded video data;
selecting the first clip having the maximum difference compared with the next first clip;
dividing the time period represented by the selected first clip into a plurality of time periods;
displaying a plurality of second clips simultaneously on the display, wherein each second clip displays a same scene but a different time period of the selected first clip;
selecting the second clip having the maximum difference compared with the next second clip;
displaying the selected second clip for searching out the exact time point having the maximum difference in the selected second clip when the time period represented by the selected second clip is shorter than a predetermined time period;
dividing the time period represented by the selected second clip into a plurality of time periods to repeatedly use the next layer of clips to search out the exact time point having the maximum difference between the next layer of clips when the time period represented by the selected second clip is not shorter than the predetermined time period; and
dividing the time period represented by the selected clip into a plurality of time periods, displaying the divided clips and selecting the divided clip having the maximum difference compared with the next divided clip repeatedly until the exact time point having the maximum difference in the recorded video data is found.

9. The method of searching for clip differences in recorded video data of a surveillance system according to claim 8, further including:
displaying a plurality of third clips simultaneously on the display, wherein each third clip displays a same scene but a different time period of the selected second clip; and
selecting the third clip having the maximum difference compared with the next second clip.

10. The method of searching for clip differences in recorded video data of a surveillance system according to claim 8, further including:
displaying N*N clips on the display when dividing the selected clip, wherein N represents a positive integer.

11. The method of searching for clip differences in recorded video data of a surveillance system according to claim 8, further including:
displaying time information on every clip.

12. The method of searching for clip differences in recorded video data of a surveillance system according to claim 8, wherein the method is implemented with software in the surveillance system.

13. The method of searching for clip differences in recorded video data of a surveillance system according to claim 8, wherein each divided clip provides the function to play or stop.

14. A method of searching for clip differences in recorded video data of a surveillance system, comprising:
dividing the recorded video data of a surveillance system into a plurality of time periods;
displaying a plurality of first clips simultaneously on a display, wherein each first clip displays a same scene but a different time period of the recorded video data;
selecting the first clip having the maximum difference compared with the next first clip when there is a practical clip difference between at least two first clips;
selecting the last first clip when there is no practical clip difference between the first clips;
dividing the time period represented by the selected first clip into a plurality of time periods;
displaying a plurality of second clips simultaneously on the display, wherein each second clip displays a same scene but a different time period of the selected first clip;
selecting the second clip having the maximum difference compared with the next second clip when there is a practical clip difference between at least two second clips;
selecting the last second clip when there is no practical clip difference between the second clips;
displaying the selected second clip for searching out the exact time point having the maximum difference in the selected second clip when the time period represented by the selected second clip is shorter than a predetermined time period;
dividing the time period represented by the selected second clip into a plurality of time periods to repeatedly use the next layer of clips to search out when the time period represented by the selected second clip is not shorter than the predetermined time period; and
dividing the time period represented by the selected clip into a plurality of time periods, displaying the divided clips and selecting the divided clip having the maximum difference compared with the next divided clip repeatedly until the exact time point having the maximum difference in the recorded video data is found.

15. The method of searching for clip differences in recorded video data of a surveillance system according to claim 14, further including:
displaying a plurality of third clips simultaneously on the display, wherein each third clip displays a same scene but a different time period of the selected second clip; and
selecting the third clip having the maximum difference compared with the next third clip when there is a practical clip difference between at least two third clips; and
selecting the last third clip when there is no practical clip difference between the third clips.

16. The method of searching for clip differences in recorded video data of a surveillance system according to claim 14, further including:
displaying N*N clips on the display when dividing the selected clip, wherein N represents a positive integer.

17. The method of searching for clip differences in recorded video data of a surveillance system according to claim 14, further including:
displaying time information on every clip.

18. The method of searching for clip differences in recorded video data of a surveillance system according to claim 14, wherein the method is implemented with software in the surveillance system.

19. The method of searching for clip differences in recorded video data of a surveillance system according to claim 14, wherein each divided clip provides the function to play or stop.
